(19) United States
(12) Patent Application Publication
(10) Pub. No.: US 2003/0035646 A1
(43) Pub. Date: Feb. 20, 2003

(54) Digital video device having a verification code thereon and method of generating a verification code

(75) Inventors: Jeremy Salvatori, University City, MO (US); Jamie Salvatori, Clayton, MO (US)

Correspondence Address: THOMPSON COBURN, LLP, ONE FIRSTAR PLAZA, SUITE 3500, ST LOUIS, MO, 63101, US

(73) Assignee: VAT 19, LLC

(21) Appl. No.: 09/933,336

(22) Filed: Aug. 20, 2001

(51) Int. Cl. H04N 5/783; H04N 5/781

(52) U.S. Cl. 386/70; 386/125

(57) ABSTRACT

A method for generating a verification code. The method comprises providing a digital video disc having data stored thereon configured to cause a digital video disc player to read the data in a manner sufficient to cause a video presentation to be displayed and to randomly generate a verification code from a plurality of alternative codes. The method further comprises operating the digital video disc player in a manner to cause the video presentation to be displayed, operating the digital video disc player in a manner such that after at least part of the video presentation is displayed the digital video disc player generates the verification code via the data of the digital video disc, and using a client computer system to input the verification code via the Internet to a host computer system.

### BACKGROUND OF THE INVENTION

This invention relates to a digital video (or versatile) disc (DVD) having a verification code thereon and a method of generating a verification code.

A DVD is a multimedia storage device for storing high grade digital video images and high quality audio. DVDs may be used for storage of movies, video clips, video presentations, and other items requiring the combination of video with other media stored in a digital format.

DVDs are commonly mass produced such that all discs in a batch have identical information stored thereon. Producing DVDs in this manner is economical and efficient. Because the information contained on each of a batch of such mass-produced DVDs is identical, it has not been contemplated that such DVDs h could be used to generate verification codes or that access to some information stored on the DVDs could be restricted.

### SUMMARY OF THE INVENTION

Among the objects and advantages of the present invention may be noted: the provision of a method for verifying whether a person has viewed certain content on a DVD; the provision of a DVD which enables a DVD player to randomly generate a verification code from a plurality of alternative codes; the provision of a method of using a DVD to generate a verification code; a method of motivating a user of a DVD to access and/or provide information to an Internet web site.

Generally, a method of the present invention is for generating a verification code. The method comprises providing a digital video disc having data stored thereon configured to cause a digital video disc player to read the data in a manner sufficient to cause a video presentation to be displayed and to randomly generate a verification code from a plurality of alternative codes. The method further comprises operating the digital video disc player in a manner to cause the video presentation to be displayed, operating the digital video disc player in a manner such that after at least part of the video presentation is displayed the digital video disc player generates the verification code via the data of the digital video disc, and using a client computer system to input the verification code via the Internet to a host computer system.

Another aspect of the present invention is a method of determining whether a code comprises a verification code. The method comprises providing a digital video disc to a client. The digital video disc has data stored thereon configured to cause a digital video disc player to read the data in a manner sufficient to cause a video presentation to be displayed and to randomly generate a verification code from a plurality of alternative codes. The method further comprises operating a host computer system. The host computer system is configured to determine whether a code received from a client computer system is one of the plurality of alternative codes. The host computer system is accessible by the client using the Internet. The method further comprises prompting the client to input a code, and operating the host computer system in a manner to determine whether the code input by the client comprises one of the plurality of alternative codes.

Another aspect of the present invention is a method comprising providing a digital video disc, and storing data on the digital video disc. The data is configured to cause a digital video disc player to randomly generate a verification code from a plurality of alternative codes.

Another aspect of the present invention comprises a 4, digital video disc. The digital video disc has data stored thereon. The data is configured to cause a digital video disc player to randomly generate a verification code from a plurality of alternative codes.

Another aspect of the present invention comprises a method of obtaining and employing an access code to access information on a digital video disc. The method comprises providing a digital video disc having data stored thereon configured to cause a digital video disc player to read the data in a manner sufficient to cause a video presentation to be displayed. The data is further configured to prevent the video presentation to be displayed until an access code is input into the digital video disc player. The method further comprises using a client computer system to access a host computer system via the Internet, obtaining the access code from the host computer system, and inputting the access code into the digital video disc player in a manner to cause the video presentation to be displayed.

Other objects and features will be in part apparent and in part pointed out hereinafter.

### BRIEF DESCRIPTION OF THE DRAWINGS

FIG. 1 is a flow chart representing a method of the present invention for using a verification code in conjunction with a DVD;

FIG. 2 is a flow chart representing a preferred method for generating the verification code;

FIG. 3 is a flow chart representing an alternative method for generating the verification code;

FIG. 4 is a flow chart showing a method for limiting access to a limited access video presentation of the DVD; and

FIG. 5 is a flow chart showing an exemplary business model for providing the access code of FIG. 4 to a client.

Corresponding reference characters indicate corresponding parts throughout the several views of the drawings.

### DESCRIPTION OF THE PREFERRED EMBODIMENTS

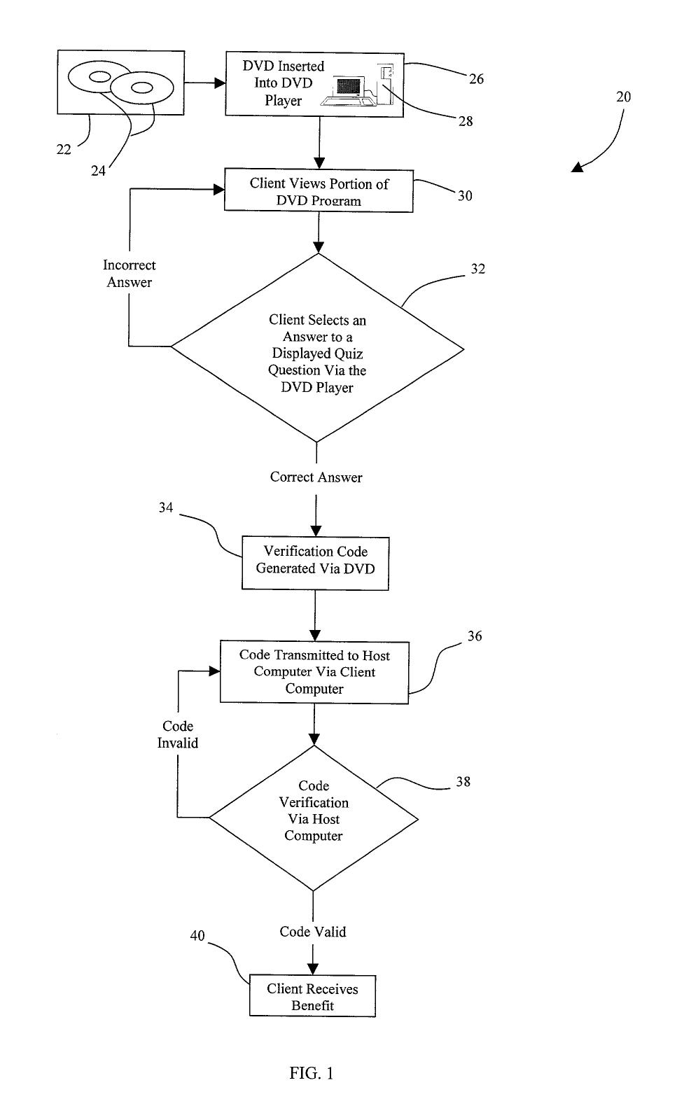

Referring now to the drawings, and first more particularly to FIGS. 1, a flow chart representing a method of the present invention is generally indicated by reference numeral 20. The flow chart 20 includes a first cell 22 showing a plurality of DVDs 24, and a second cell 26 showing a DVD player 28. The DVD player 28 is a component of a client computer system and is preferably coupled to the other components of the client computer system. However, it is not necessary for the DVD player to be coupled (directly or indirectly) to the client computer system.

Preferably, at least one of the DVDs is provided to a client. The DVDs 24 are preferably mass produced such that the information content (i.e., data) of each of the DVDs is identical to the information content of each of the other DVDs. The DVD 24 is configured to cause the digital video disc player 28 to read the data in a manner sufficient to cause a video presentation to be displayed and to randomly generate a verification code from a plurality of alternative codes. The video presentation may be a continuing education presentation (e.g., continuing education seminars for doctors, nurses, lawyers, insurance agents, real estate agents, certified public accountants, etc.), a presentation for use in home-schooling, a presentation for trade school education (e.g., engine repair, air conditioning, home inspection, etc.), or any other suitable video presentation. Preferred methods of generating the verification code are discussed in greater detail below. The data stored on the DVD 24 is also preferably configured to enable the DVD player 28 to read the data in a manner to cause a quiz to be displayed. The quiz preferably comprises one or more questions corresponding to the video presentation.

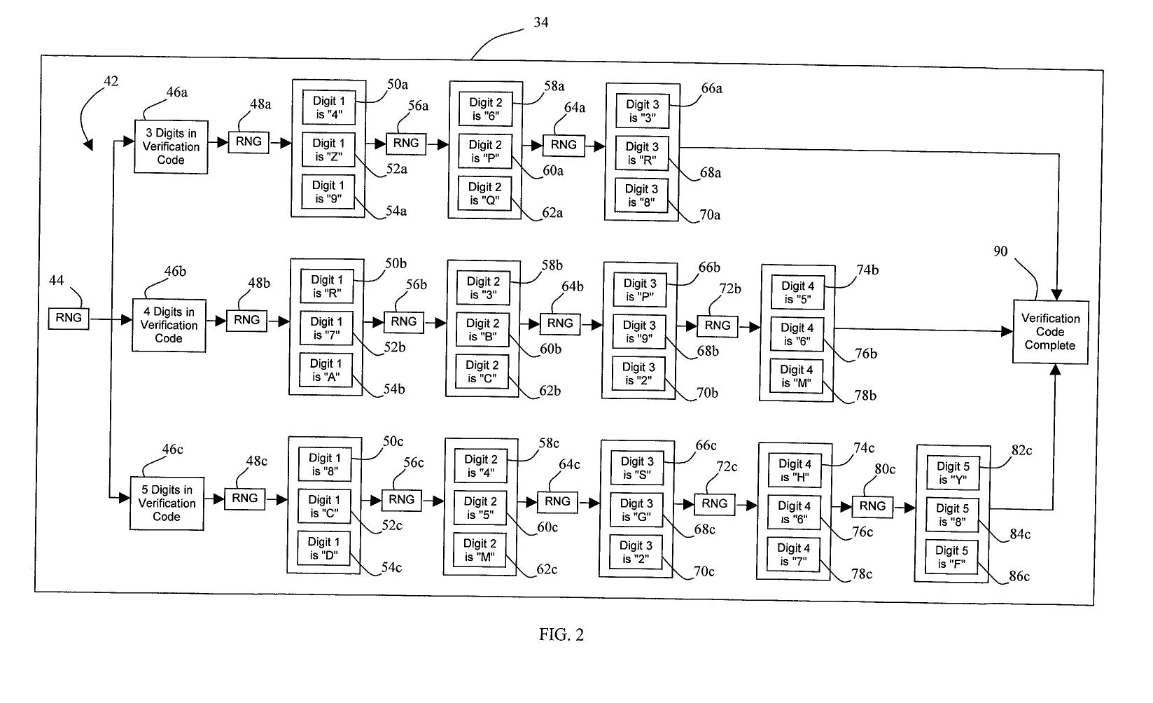

The flow chart 20 further includes a third cell 30, which represents the step of the client operating the DVD 24 and DVD player 28 in a manner such that the video presentation is displayed. The video presentation may be displayed on a television, computer monitor, or any other suitable display mechanism. After the video presentation is displayed, the DVD 24 and DVD player 28 are operated in a manner to cause the quiz to be displayed. The quiz preferably comprises a plurality of multiple choice questions concerning the video presentation. Preferably, the questions are serially displayed with only one question on each display menu. The DVD 24 and DVD player 28 are configured to enable the client to select one of a plurality of possible answers. The client may be able to make a selection via a mouse control, a touch screen, a conventional remote control unit, or by any other suitable mechanism without departing from the scope of this invention. If the client correctly answers a first one of the questions, then another menu will preferably be displayed with a second question thereon. If the client correctly answers all of the questions of the quiz, then as represented by a fourth cell 32 of the flow chart 20, the DVD 24 and DVD player 28 will cause the verification code to be generated as depicted by a fifth cell 34. If the client fails to correctly answer at least a sufficient number of the questions of the quiz (i.e., if the client fails the quiz), then the DVD 24 and DVD player 28 may cause the video presentation to be repeated. Preferably, upon failing the quiz, the DVD 24 and DVD player 28 automatically cause a suitable menu to be displayed to inform the client of the failing score. The DVD 24 may be configured such that the client has to correctly answer at least so many questions, e.g., three of four questions. This may be accomplished by using different menu paths. For example, if the client correctly answers the first question but incorrectly answers the second question, the menu containing the third question will be a different menu than if the client correctly answered the first two questions, even though both of the menus containing the third questions may appear to the client as being identical. By displaying different menus depending on the answers given to the questions, the DVD 24 and DVD player 28 may be operated to either require the client to replay the video presentation or display an initial menu for the generation of the verification code. Details as to how the verification code is generated is discussed in greater detail below with reference to FIG. 2.

As indicated by the sixth cell 36 of the flow chart 20, after the client obtains the verification code, he or she uses the client computer system to input the verification code via the Internet to a host computer system. Preferably, the host computer system is configured to prompt the client to enter a code. The host computer system is also preferably configured to determine whether a code received from a client computer system is one of the plurality of alternative codes. Thus, as indicated by the seventh cell 38 of the flow chart 20, the host computer system makes such determination. If the host computer system determines that the code input via the client computer system is invalid, the client is asked to re-enter the code or is ejected from the host website. If the host computer system determines that the code input via the client computer system is valid, then the host computer system is operated to provide a benefit to the client as indicated by the eighth cell 40. Preferably, the benefit the client receives depends upon the purpose for the DVD 24. For example, if the DVD video presentation is a continuing education course or seminar, then obtaining the verification code may be proof that the client completed the course or seminar and successfully passed the quiz. In this example, the benefit the client may receive by correctly inputting the verification code into the host computer is credit for successful completion of the course or seminar. Such credit may be acknowledged by entry of client information into the host computer and/or by sending an appropriate certificate to the client. Under appropriate circumstances, the benefit may also entitle the client to some type of monetary award or some type of discount.

The method of FIG. 1 may be especially useful for interactive marketing. A company (i.e., host) may distribute DVDs to prospects (i.e., clients) by direct mail or through organizations such as churches, schools, and trade associations, depending on target demographic. The host links the completion of a video presentation of the DVD 24 to some benefit for the client. The client obtains the benefit and the host obtains a new customer. One example is an interactive driver safety DVD for teens. In this example, an insurance company would distributes DVDs to teens, perhaps through a school systems. The video presentation of the DVD is intended to teach the children driver safety. To motivate the children to view the video presentation and complete a quiz, the insurance company offers a discount on auto insurance. After obtaining the verification code, the client (teen) accesses the company website via the Internet and enters the verification code upon being prompted to do so. The client obtains education and an insurance discount, and the insurance company obtains a new customer (and possibly the insurance accounts of the teens parents).

FIG. 2 is a verification code flow chart, generally indicated at 42, representing a preferred method for generating the verification code. The diagram 42 constitutes the logical details of the fifth cell 34 of FIG. 1. The DVD 24 preferably includes sufficient software instructions (command sequences) for generation of a variable length verification code. The verification code ultimately generated preferably comprises a plurality of digits (characters). Each digit may be an alpha-numeric character or any other symbol without departing from the scope of this invention. If the client passes the quiz represented by the fourth cell 34 (FIG. 1), then the DVD 24 and DVD player 28 are preferably operated such that a random number generator (“RNG”) 44 is used to select one of three paths for determination of the verification code. The random number generator may comprise software instructions of the DVD 24 and/or the DVD player 28. Depending on the number generated by the random number generator, the DVD 24 and DVD player 28 will preferably cause one of three possible digit length menus 46a, 46b, 46c to be displayed. Menu 46a informs the client that the verification code ultimately generated will have three digits. The DVD 24 is configured such that if menu 46a is displayed, the DVD and DVD player will generate a three digit verification code. Menu 46b informs the client that the verification code ultimately generated will have four digits. The DVD 24 is configured such that if menu 46b is displayed, the DVD and DVD player will generate a four digit verification code. Menu 46c informs the client that the verification code ultimately generated will have five digits. The DVD 24 is configured such that if menu 46c is displayed, the DVD and DVD player will generate a five digit verification code.

If menu 46a is displayed, the client initiates generation of the first digit of the verification code by, for example, pressing a suitable button (not shown) which may be a button on the menu or the “enter” button of a remote control unit. Upon such initiation, a random number generator 48a causes one of three possible first digit menus 50a, 52a, 54a to be displayed. The first digit menus 50a, 52a, 54a inform the client as to the first digit of the verification code. If menu 50a is displayed, it informs the client that the first digit of the code is “4.” If menu 52a is displayed, it informs the client that the first digit of the code is “Z.” If menu 54a is displayed, it informs the client that the first digit of the code is “9.” Preferably, the client is instructed to either memorize or write down each digit of the verification code. The client then initiates generation of the second digit of the verification code such that a random number generator 56a causes one of three possible second digit menus 58a, 60a, 62a to be displayed. The second digit menu displayed informs the client as to the second digit of the verification code. The client then initiates generation of the third digit of the verification code such that a random number generator 64a causes one of three possible third digit menus 66a, 68a, 70a to be displayed. The third digit menu displayed informs the client as to the third digit of the verification code. The client then advances to the next menu 90 which informs the client that the verification code is complete. Thus, in the embodiment of FIG. 2, if the initial menu 46a is displayed, the three digit verification code may be “4P3,” “ZPR,” “923,” etc. Once the client obtains the verification code, he/she may then input the code in the manner discussed above with reference to cell 36 of FIG. 1.

If menu 46b is displayed, the client initiates generation of the digits of the verification code in a manner similar to that if menu 46a is displayed. In particular, if menu 46b is displayed, the client initiates generation of the first digit of the verification code such that a random number generator 48b causes one of three possible first digit menus 50b, 52b, 54b to be displayed. The client then initiates generation of the second digit of the verification code such that a random number generator 56b causes one of three possible second digit menus 58b, 60b, 62b to be displayed. The client then initiates generation of the third digit of the verification code such that a random number generator 64b causes one of three possible third digit menus 66b, 68b, 70b to be displayed. The client then initiates generation of the fourth digit of the verification code such that a random number generator 72b causes one of three possible fourth digit menus 74b, 76b, 78b to be displayed. Thus, in the embodiment of FIG. 2, if the initial menu 46b is displayed, the four digit verification code may be “R3P5,” “73PM,” “RC26,” etc. The client then advances to the next menu 90 which informs the client that the verification code is complete. Once the client obtains the verification code, he/she may then input the code in the manner discussed above with reference to cell 36 of FIG. 1.

If menu 46c is displayed, the client initiates generation of the digits of the verification code in a manner similar to that if menu 46a or menu46b is displayed. In particular, if menu 46c is displayed, the client initiates generation of the first digit of the verification code such that a random number generator 48c causes one of three possible first digit menus 50c, 52c, 54c to be displayed. The client then initiates generation of the second digit of the verification code such that a random number generator 56c causes one of three possible second digit menus 58c, 60c, 62c to be displayed. The client then initiates generation of the third digit of the verification code such that a random number generator 64c causes one of three possible third digit menus 66c, 68c, 70c to be displayed. The client then initiates generation of the fourth digit of the verification code such that a random number generator 72c causes one of three possible fourth digit menus 74c, 76c, 78c to be displayed. The client then initiates generation of the fifth digit of the verification code such that a random number generator 80c causes one of three possible fifth digit menus 82c, 84c, 86c to be displayed. Thus, in the embodiment of FIG. 2, if the initial menu 46c is displayed, the five digit verification code may be “D2G7F,” “C5SH5,” “DM268,” etc. The client then advances to the next menu 90 which informs the client that the verification code is complete. Once the client obtains the verification code, he/she may then input the code in the manner discussed above with reference to cell 36 of FIG. 1.

Preferably, there is little or no overlap in the characters used for each corresponding digit of varying length verification codes. In other words, it is preferred, for example, that none of the possible characters for the first digit of a three digit verification code is the same as any of the possible characters for the first digit of a four or five digit verification codes. Although the verification code has been described as having 3, 4 or 5 digits, it is to be understood that verification codes of other lengths could be generated without departing from the scope of the present invention. Also, the DVD 24 could be configured to generate verification codes only of fixed lengths (e.g., seven digits) without departing from the scope of the present invention. Further, although only three possible menus are shown with each of the random number generators of the verification code flow chart 42, it is to be understood that more menus, fewer menus, or a combination of both may be employed without departing from the scope of this invention. For example, the DVD 24 could be configured such that the verification code ultimately generated has anywhere from two to ten digits, and such that one of the digits may be selected from one of two possible characters and another of the digits may be selected from one of six possible characters.

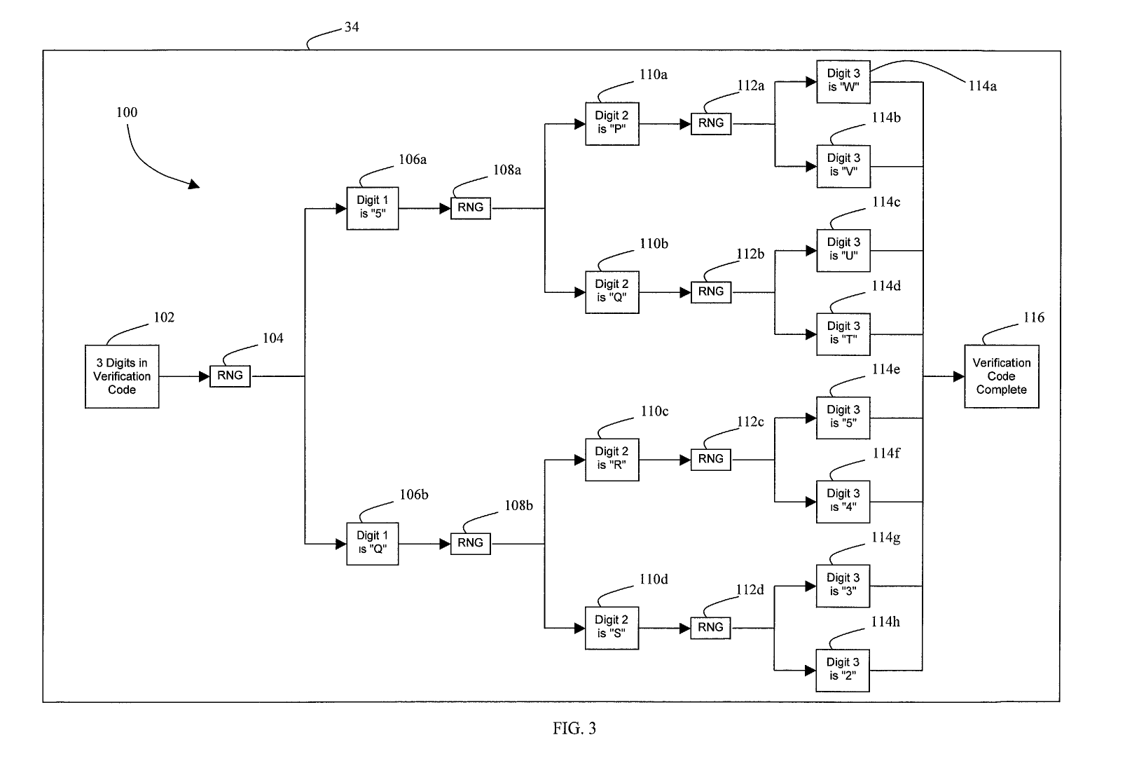

FIG. 3 is a verification code flow chart, generally indicated at 100, representing an alternative method for generating the verification code. Like the diagram 42 of FIG. 2, the diagram 100 of FIG. 3 constitutes the logical details of the fifth cell 34 of FIG. 1. For simplicity, the code flow chart 100 is described as generating a three digit verification code with each random number generator choosing between two possible menus. However, it is to be understood that methods similar to the method of FIG. 3 may be employed to generate verification codes of any length and for the random number generators to choose from among any predetermined number of menus.

With of method of FIG. 3, each digit other than the first digit is dependent upon the previous digit. If the client passes the quiz represented by the fourth cell 34 (FIG. 1), then the DVD 24 and DVD player 28 are preferably operated such that an initial menu 102 is displayed. The initial menu 102 informs the client how many digits are in the verification code and may instruct the client to write down or memorize each digit as it is displayed. After the initial menu 102 is displayed, the client initiates generation of the first digit of the verification code such that a random number generator 104 causes one of two possible first digit menus 106a, 106b to be displayed. If the first digit menu 106a is displayed, the client then initiates generation of the second digit of the verification code such that a random number generator 108a causes one of two possible second digit menus 110a, 110b to be displayed. If the first digit menu 106b is displayed, the client then initiates generation of the second digit of the verification code such that a random number generator 108b causes one of two possible second digit menus 110c, 110d to be displayed. If the second digit menu 110a is displayed, the client then initiates generation of the third digit of the verification code such that a random number generator 112a causes one of two possible third digit menus 114a, 114b to be displayed. If the second digit menu 110b is displayed, the client then initiates generation of the third digit of the verification code such that a random number generator 112b causes one of two possible third digit menus 114c, 114d to be displayed. If the second digit menu 110c is displayed, the client then initiates generation of the third digit of the verification code such that a random number generator 112ccauses one of two possible third digit menus 114e, 114f to be displayed. If the second digit menu 110d is displayed, the client then initiates generation of the third digit of the verification code such that a random number generator 112d causes one of two possible third digit menus 114g, 114h to be displayed. After any of the third digit menus are displayed, the client advances to the next menu 116 which informs the client that the verification code is complete. As shown in the specific embodiment of FIG. 3, the verification code ultimately obtained may be “5PW,” 5QT,” “QR4,” “QS3,” etc. Once the client obtains the verification code, he/she may then input the code in the manner discussed above with reference to cell 36 of FIG. 1.

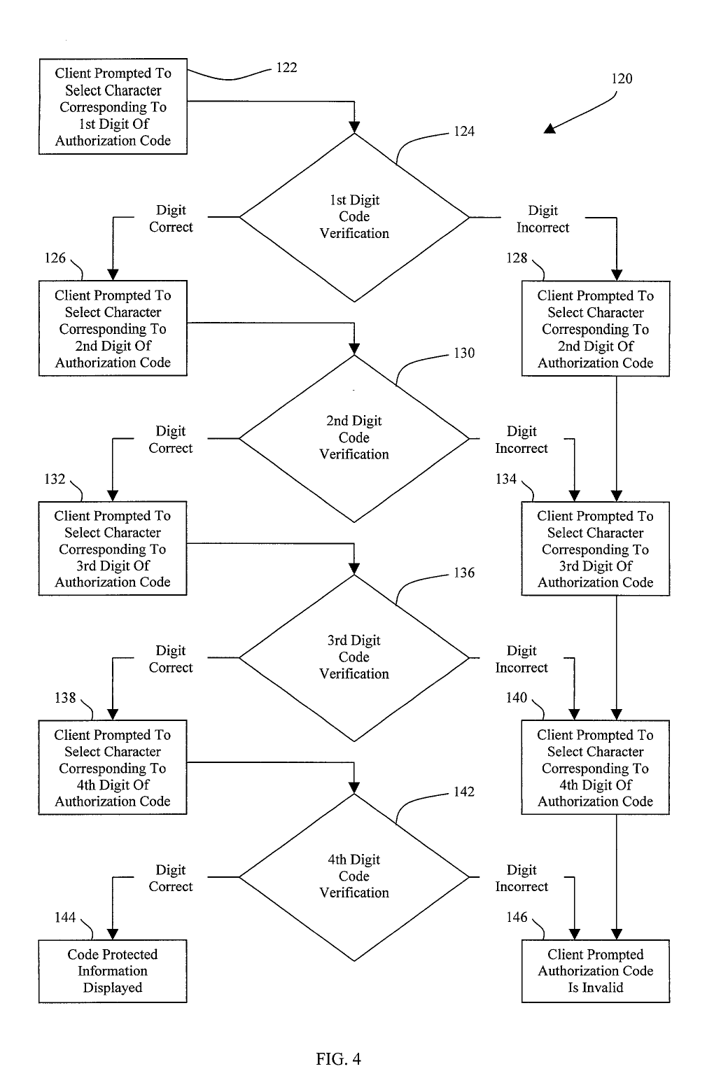

Referring now to FIG. 4, the DVD 24 of FIG. 1 is preferably configured to prevent a limited access video presentation of the DVD from being displayed until an access code is input into the DVD player 28. FIG. 4 is a flow chart, generally indicated at 120, showing a preferred manner in which the DVD 24 is configured for limiting access to the limited access video presentation. The flow chart 120 of FIG. 4 also represents the preferred method for obtaining access to the limited access video presentation. In other words, the DVD is configured to permit access to the limited access video presentation in the manner shown in FIG. 4.

The flow chart 120 preferably includes a first cell 122, a second cell 124, a third cell 126, and a fourth cell 128. The first cell 122 represents the DVD player being operated in a manner to display a first authorization menu (not shown). The first authorization menu preferably includes a plurality of buttons each corresponding to a different character (e.g., numerals zero through nine). The client is prompted to select the character corresponding to the first digit of the authorization code. As represented by the second cell 124, the DVD 24 and DVD player 28 are operated in a manner to determine whether the character selected by the client corresponds to the first digit of the access code. If the character selected by the client corresponds to the first digit of the access code, then the steps of the third cell 126 are initiated. If the character selected by the client does not correspond to the first digit of the access code, then the steps of the fourth cell 128 are initiated. The third cell 126 represents the DVD player being operated in a manner to display an effective second authorization menu (not shown). The effective second authorization menu preferably includes a plurality of buttons. Preferably the buttons of the effective second authorization menu are the same as the buttons of the first authorization menu. With the effective second authorization menu, the client is prompted to select the character corresponding to the second digit of the authorization code.

As represented by the fifth cell 130, the DVD 24 and DVD player 28 are operated in a manner to determine whether the i character of the effective second menu selected by the client corresponds to the second digit of the access code. If the character of the effective second authorization menu selected by the client corresponds to the second digit of the access code, then the steps of the sixth cell 132 are initiated. If the character selected by the client does not correspond to the second digit of the access code, then the steps of the seventh cell 134 are initiated.

The fourth cell 128 represents the DVD player being operated in a manner to display an ineffective second authorization menu. The ineffective second authorization menu preferably appears to be identical to the effective second authorization menu, but the display of the ineffective second authorization menu ensures that the code ultimately entered by the client will be found to be invalid. With the ineffective second authorization menu of the fourth cell 128, the client is prompted to select the character corresponding to the second digit of the authorization code. Preferably, regardless of the character of the ineffective second authorization menu selected by the client, the selection results in the steps of a seventh cell 134 being initiated.

The flow chart 120 further includes eight, ninth, tenth, eleventh, twelfth, and thirteenth cells 136, 138, 140, 142, 144, 146, respectively. From the flow chart 120, it is to be understood that the steps of cell 144 are initiated only if the client correctly enters every digit of the authorization code. The twelfth cell 144 represent the client obtaining access to the limited access video presentation. If the client fails to correctly enter at least one digit, the steps of the thirteenth cell 146 will be initiated. The thirteenth cell 146 represents the client being denied access to the limited access video presentation. Although the access code of FIG. 4 is described as being a four digit access code, it is to be understood that other length access codes may be employed without departing from the scope of this invention.

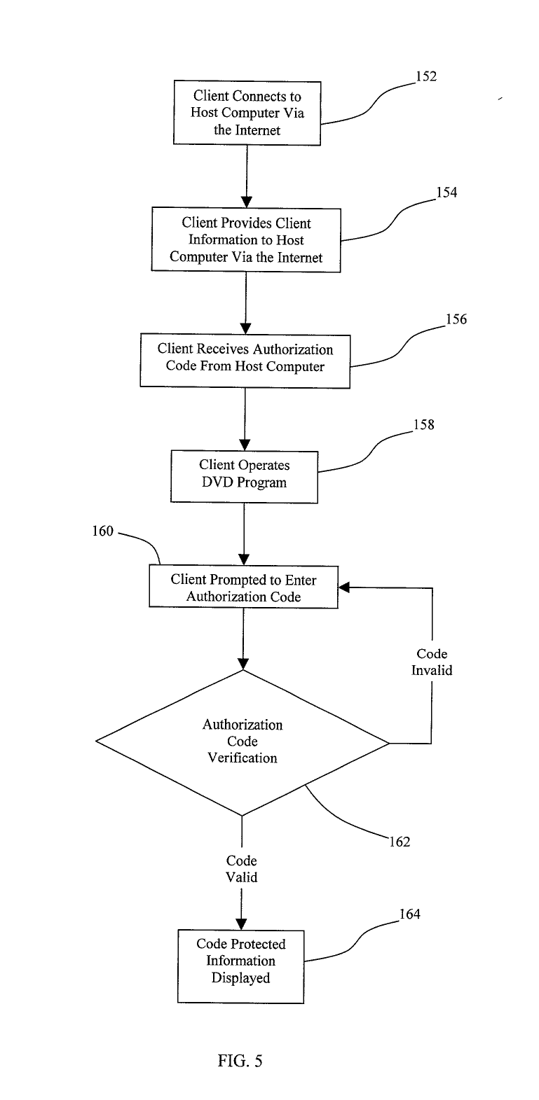

FIG. 5 is a flow chart 150 showing an exemplary business model for providing the access code of FIG. 4 to the client. First, the client accesses the host computer system via the Internet, as indicated via cell 152. As indicated via cell 154, the host computer system prompts the client to perform an activity (e.g., complete a survey, complete a quiz, etc.). Upon completion of the task indicated by cell 154, the host computer provides the access code to the client, as indicated by cell 156. As indicated by cell 158, the client then operates the DVD 24 and the DVD player 28 in a manner to attempt to access the limited access video presentation. Upon being prompted to do so, the client enters the access code as indicated by cell 160. Preferably, the method of providing access to the limited access video presentation is the same as that described above with reference to FIG. 4. As indicated by cell 162, upon entry of the access code by the client, the DVD 24 and DVD player 28 are operated in a manner to verify whether the code entered by the client is correct. As indicated by cell 164, If the code entered by the client is correct, the client is provided access to the limited access video presentation. If the code entered by the client is incorrect, the client is preferably instructed to reenter the code or is otherwise informed that access is denied.

In view of the above, it will be seen that the several objects of the invention are achieved and other advantageous results attained.

As various changes could be made in the above constructions and methods without departing from the scope of the invention, it is intended that all matter contained in the above description or shown in the accompanying drawings shall be interpreted as illustrative and not in a limiting sense.

What is claimed is:

1. A method comprising:
providing a digital video disc having data stored thereon configured to cause a digital video disc player to read the data in a manner sufficient to cause a video presentation to be displayed and to randomly generate a verification code from a plurality of alternative codes;
operating the digital video disc player in a manner to cause the video presentation to be displayed;
operating the digital video disc player in a manner such that after at least part of the video presentation is displayed, the digital video disc player generates the verification code via the data of the digital video disc;
using a client computer system to input the verification code via the Internet to a host computer system.

2. A method as set forth in claim 1 wherein the digital video disc player constitutes a part of the client computer system.

3. A method as set forth in claim 1 wherein the step of using the client computer system to input the verification code to the host computer system comprises inputting the verification code to the host computer system in a manner to obtain a benefit.

4. A method as set forth in claim 1 wherein the data stored on the digital video disc is configured to enable the digital video disc player to read the data in a manner to cause a quiz to be displayed, the quiz comprising at least one question corresponding to the video presentation, the method further comprising operating the digital video disc player in a manner to cause the quiz to be displayed.

5. A method as set forth in claim 4 wherein the data stored on the digital video disc is configured such that the digital video disc player generates the verification code after the at least one question is correctly answered, the method further comprising operating the digital video disc player in a manner to correctly answer the at least one question to thereby enable the digital video disc player to generate the verification code.

6. A method comprising:
providing a digital video disc to a client, the digital video disc having data stored thereon configured to cause a digital video disc player to read the data in a manner sufficient to cause a video presentation to be displayed and to randomly generate a verification code from a plurality of alternative codes;
operating a host computer system, the host computer system being configured to determine whether a code received from a client computer system is one of the plurality of alternative codes, the host computer system being accessible by the client using the Internet;
prompting the client to input a code;
operating the host computer system in a manner to determine whether the code input by the client comprises one of the plurality of alternative codes.

7. A method as set forth in claim 6 further comprising providing a benefit to the client if the host computer system determines that the code input by the client comprises one of the plurality of alternative codes.

8. A method comprising:
providing a digital video disc;
storing data on the digital video disc, the data being configured to cause a digital video disc player to randomly generate a verification code from a plurality of alternative codes.

9. A method as set forth in claim 8 wherein:
the step of providing a digital video disc comprises providing a plurality of digital video discs;
the step of storing the data comprises storing the data on each of the plurality of digital video discs such that each of the plurality of digital video discs has identical data stored thereon.

10. A method as set forth in claim 8 wherein the data comprises at least a first data set and a second data set, the first data set comprising a plurality of first data set portions and the second data set comprising a plurality of second data set portions, the step of storing the data on the digital video disc comprising storing the data on the disc in a manner to enable the digital video disc player to randomly select one of the first data set portions and to randomly select one of the second data set portions such that said one of the first data set portions corresponds to a first code portion of the verification code and said one of the second data set portions corresponds to a second code portion of the verification code.

11. A method as set forth in claim 10 wherein the first data set is different than the second data set.

12. A method as set forth in claim 8 wherein the step of storing the data on the digital video disc comprises storing the data on the disc in a manner to enable the digital video disc player to randomly generate the verification code such that the verification code comprises a plurality of alpha-numeric digits, the data being configured to enable the digital video disc player to randomly select each digit from a corresponding one of a plurality of sets of alpha-numeric digits.

13. A method as set forth in claim 12 wherein each of the plurality of sets contains a plurality of alpha-numeric digits.

14. A method as set forth in claim 8 wherein the step of storing the data on the digital video disc comprises storing the data on the disc in a manner to enable the digital video disc player to randomly generate the verification code such that the verification code comprises a plurality of digits, the data being configured to enable the digital video disc player to randomly select the number of digits to be in the verification code.

15. A digital video disc having data stored thereon, the data being configured to cause a digital video disc player to randomly generate a verification code from a plurality of alternative codes.

16. A digital video disc as set forth in claim 15 wherein the verification code comprises at least a first code portion and a second code portion.

17. A digital video disc as set forth in claim 16 wherein the data comprises a first data set and a second data set, the first data set comprising a plurality of first data set portions and the second data set comprising a plurality of second data set portions, the data being configured to cause the digital video disc player to randomly select one of the first data set portions and to randomly select one of the second data set portions, the first code portion of the verification code corresponding to said one of the first data set portions, the second code portion of the verification code i corresponding to said one of the second data set portions.

18. A digital video disc as set forth in claim 17 wherein the first code portion comprises a first alpha-numeric digit and the second code portion comprises a second alphanumeric digit, the first digit of the verification code corresponding to said one of the first data set portions, the second digit of the verification code corresponding to said one of the second data set portions.

19. A method comprising:
providing a digital video disc having data stored thereon configured to cause a digital video disc player to read the data in a manner sufficient to cause a video presentation to be displayed, the data further being configured to prevent the video presentation to be displayed until an access code is input into the digital video disc player;
using a client computer system to access a host computer system via the Internet;
obtaining the access code from the host computer system; and
inputting the access code into the digital video disc player in a manner to cause the video presentation to be displayed.

20. A method as set forth in claim 19 further comprising operating the client computer system in a manner to provide client information to the host computer system, the step of providing client information to the host computer system occurring before the step of obtaining the access code from the host computer system.

21. A digital video disc having data stored thereon configured to cause a digital video disc player to read the data in a manner sufficient to cause a video presentation to be displayed, the data further being configured to prevent the video presentation to be displayed until an access code is input into the digital video disc player.

22. A digital video disc as set forth in claim 21 wherein the access code comprises at least first and second digits, the data being configured to cause a first menu to be displayed, the first menu having a first set of characters thereon, the data being configured to prompt the user to chose one of the characters from the first set of characters, the data being configured to cause a second menu to be displayed upon the user choosing from the first set of characters a character which corresponds to the first digit, the data being configured to cause a third menu to be displayed upon the user choosing from the first set of characters a character which fails to correspond to the first digit, the second menu having a second set of characters thereon, the data being configured to prompt the user to chose one of the characters from the second set of characters.
